(19) United States
(12) Patent Application Publication
(10) Pub. No.: US 2015/0132711 A1
(43) Pub. Date: May 14, 2015

(54) PLASMA TREATMENT DEVICE

(71) Applicant: Linde Aktiengesellschaft, Munich (DE)

(72) Inventor: Rodney Stewart Mason, Blackpill (GB)

(21) Appl. No.: 14/395,911

(22) PCT Filed: Apr. 24, 2013
(86) PCT No.: PCT/GB2013/000181

§ 371 Date: Oct. 21, 2014

(30) Foreign Application Priority Data
Apr. 24, 2012 (GB) 1207151.0

(51) Int. Cl. H01J 37/04; H01J 37/32; H01J 37/244; A61C 19/06

(52) U.S. Cl. CPC H01J 37/04; A61C 19/066; H01J 37/3244; H01J 37/32467; H01J 37/244; H01J 37/32541
USPC 433/80; 315/111.31

(57) ABSTRACT

A plasma treatment device comprises a body portion housing a battery, a gas cylinder, a power supply circuit and a plasma generator comprising a pair of electrodes. The device includes a detachable applicator portion and an elongate duct extending from the generator to convey generated plasma to an outlet of the duct and for directing a plasma plume formed at the outlet onto a treatment area. An annular electrode is disposed at the duct outlet and is connected to the power supply circuit via an elongate electrical conductor. The annular electrode conducts electrons in the plasma away from the plasma plume to avoid sensation caused by resultant current flow. A circuit may be provided to measure the current flow from the annular electrode, the circuit allowing adjustment of the power supplied to the pair of electrodes based on the measured current.

The present invention relates to a plasma treatment device and more particularly to a plasma treatment device for reducing the flow of charged particles from an exit aperture of a plasma generator of the device.

A plasma is usually regarded as an overall electrically neutral gas of ions and free electrons. When such a gas exists at very high temperatures in a stable state, in which the ions and electrons are in thermal equilibrium with themselves and with any neutral species present, it is called a thermal (or ‘hot’) plasma. A non-thermal plasma (i.e. a ‘cold’ plasma) may also exist, in which the plasma exists in a short-lived temporary state, but which is in almost thermal and kinetic isolation from the containing gas. Such plasmas may exist in highly dilute form within a neutral support gas which has an overall gas temperature range spanning room temperature and body temperature, making cold plasmas suitable for use in many applications such as biomedical applications, oral care, personal grooming and home care etc.

The potential utility of non-thermal plasmas in is based on the presence of certain active component, for example:
1. Charged particles i.e. ions and electrons. The charged particles are reactive species and will thus react with the gases and/or fluids in a treatment region to form other ionised species. For example, in the mouth, the charged particles will react to form water ion clusters. The electrons may become energised to create, by collision with breath air, further reactive species, such as hydroxyl radicals, the action of which is described below.
2. Free radicals i.e. atomic and molecular species with unpaired electrons including unpaired oxygen atoms and hydroxyl groups (O, OH). These types of free radical are highly oxidising, enabling them to penetrate and destroy bacterial cell walls. Furthermore, free radicals act to break down stains. Within oral care, the free radicals act to break down stains within the tooth structure and thus act as an effective tooth whitener.

One method of generating a non-thermal plasma is to generate a high voltage waveform using a low voltage AC power supply or a DC signal pulse generator, along with an amplifier or high voltage transformer. The high voltage waveform drives an electrical discharge, which is the source of the plasma. Our co-pending international patent application WO 2010/103263 discloses a plasma generation device for use in oral care. In use, a plasma plume is generated between two electrodes of a plasma generator. The plasma plume has an associated afterglow that will naturally decay. However, initial research indicates that there is a very small discharge current that travels downstream through the afterglow and out of the device, into the air or to an earthed target such as a tooth. Detailed examination reveals a series of very short-lived current spikes, at the frequency of the power source. This is caused by brief periods of electron impact ionisation as the oscillating field passes down the plasma plume, coinciding with the passage of the highest-field region which can excite the electrons already carried down from the main discharge, or the upstream afterglow. The current is typically in the region of fractions of a milliamp but if of a high enough magnitude and if directed towards a patient's skin or gums, it has been observed to cause a slight tingling sensation, particularly if directed towards sensitive areas such as an oral cavity.

Accordingly, an object of the present invention is to reduce the flow of electric current from the plasma generator whilst still producing a plasma effective in, for example, oral care.

In accordance with the present invention, there is provided a plasma treatment device comprising a plasma generator for generating a plasma in the form of a non-thermal gaseous species in a gas flow, an elongate duct extending from the generator for conveying the generated plasma to an outlet disposed at the distal end of the duct and for directing a plasma plume formed at the outlet onto a treatment area, wherein the duct comprises an electrode disposed at the outlet for reducing the number of electrons in the plasma exiting therefrom, the electrode being connected to a current sink via an electrical conductor to conduct the electrons away.

It will be appreciated that the channeling of electrons in the plasma towards the electrode substantially reduces the electric current of the plasma plume. Accordingly, the tingling sensation associated with the electric current of the plasma plume is substantially alleviated.

It will also be appreciated that the channeling of electrons does not affect other components of the plasma such as the free radicals and excited gas states. The device therefore provides effective treatment through the bactericidal (and whitening in the case or oral care) action of the free radicals and excited gas states. Whilst there may be concern that a reduction in electric current could potentially reduce the efficacy of the device, preliminary tests in oral care applications have shown that this is not the case.

Preferably the electrode is annular and surrounds the outlet of the duct adjacent to the point where the plasma emerges into the atmosphere. This arrangement enables optimal capture of electrons within the plasma plume before the plasma plume exits the duct.

The duct preferably comprises an elongate tubular body formed of an insulating material such as plastics, glass or ceramics and defines a flow passage for the plasma, the electrode being disposed at the distal end of the body.

Preferably the electrical conductor extends along the body at a position which is disposed away from the flow duct and is therefore insulated therefrom so that the electrons are only attracted towards the electrode.

In one embodiment, the electrode comprises a conductive member such as a cap engaged to the insulative body. The body may be formed of a molded material with the conductive member being held in-situ by the material.

In another embodiment, the electrode comprises a conductive region deposited on the insulative body, for example by applying a conductive ink or paint or metal coating

In a further embodiment, the electrode comprises a molded region of conductive plastics material disposed on a molded body of insulating plastics material.

The electrode preferably forms a valve arranged to close the outlet in the absence of gas flow therethrough. Whilst the device is in use, the pressure associated with the plasma plume preferably opens valve, thereby allowing the plasma plume to pass out of the outlet. It will be appreciated that the outlet may come into contact with fluids such as blood, mucus, saliva, water, antibacterial fluid etc. prior to use and/or following use. Advantageously, the provision of a valve arranged to close the outlet in the absence of gas flow therethrough prevents fluid or other contaminants from entering the duct and potentially damaging the device. Furthermore, the valve reduces the possible ingress of atmospheric air into the device and the possible leakage of gas from which the plasma is formed.

Preferably a monitoring circuit monitors the current flowing along the electrical conductor and controls a parameter of an operating voltage or current applied to the plasma generator, so as to provide feedback.

The current sink may comprise an electrical earth. Alternatively or additionally, the electrode may be connected to a terminal of a power supply of the device, the latter acting as the current sink when earth is not used.

The plasma treatment device preferably comprises a body portion which houses the plasma generator and an applicator portion which comprises the duct. The body portion of the device may form a handle for holding the device whilst the applicator is applied to the treatment area.

Preferably the applicator is detachable from the body portion, the body and applicator portions of the device comprising complimentary engaging terminals for connecting the conductor to the body portion and hence providing a conducting path to the current sink.

The power supply is preferably disposed in the body portion of the device and preferably comprises a battery or batteries.

An embodiment of the present invention will now be described by way of example only and with reference to the accompanying drawings, in which:

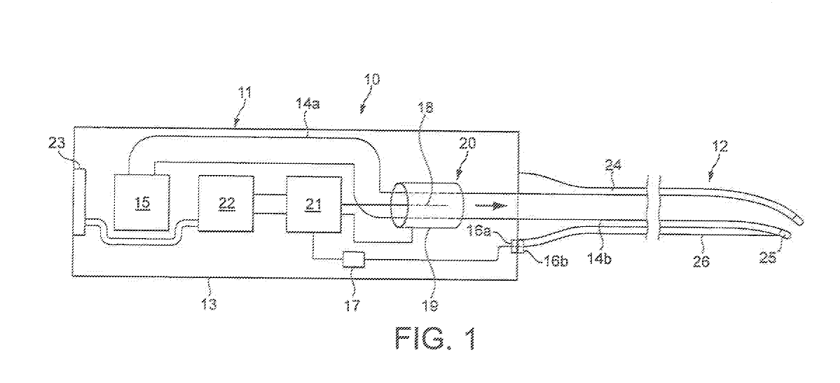

FIG. 1 is a schematic diagram of a plasma treatment device in accordance with the present invention; and

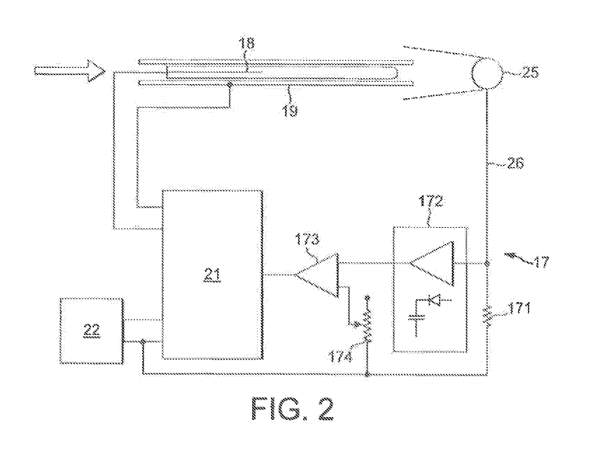

FIG. 2 is a schematic circuit diagram of the device of FIG. 1

Referring to FIG. 1 of the drawings, there is shown a plasma treatment device 10 comprising a body portion 11 and an elongate applicator portion 12.

The body portion 11 comprises a generally tubular housing 13, which forms a handgrip for holding the device when in use. Within the housing 13, there is provided a first duct 14a with inlet sealingly connected to a replaceable gas cylinder 15 containing a mixture of helium and argon gases and outlet disposed at a distal end wall of the housing 13. Also disposed at the distal end wall of the housing 13 is an electrical terminal 16a connected to a monitoring circuit 17.

A pair of electrodes 18, 19 are arranged for generating a plasma in a plasma generating portion 20 of the first duct 14a. The pair of electrodes 18, 19 comprises an inner electrode 18 disposed substantially radially centrally within the plasma generating portion 20 of the first duct 14a and an outer electrode 19 is disposed radially outside the plasma generating portion 20 of the first duct 14a. A power supply circuit 21 is arranged for generating a high voltage across a pair of electrodes 18, 19. The power supply circuit 21 is arranged for receiving an input from the monitoring circuit 17. The power supply circuit 21 receives power from a rechargeable battery 22, this power preferably being a low DC voltage. A proximal end wall of the housing 13 comprises an electrical connector 23 for connecting the body to an external power source for re-charging the battery 22.

The applicator portion 12 of the device comprises a proximal end arranged for detachably engaging with the second end wall of the housing of the body portion 11. The applicator portion 12 further comprises an elongate tubular body 24 formed of plastics material. A second duct 14b extends longitudinally through the elongate tubular body 24 and is arranged for communicating a plasma from an outlet of the first duct 14a to a mouth thereof. The second duct 14b comprises an inlet disposed at the proximal end of the applicator portion 12, the inlet of the second duct 14b being arranged for detachably and sealingly engaging with the outlet of the first duct 14a. A distal end of the applicator portion 12 is provided with an annular electrode 25, which extends around the mouth of the second duct 14b. An elongate conductor 26 such as a wire extends from the electrode 25 axially along the elongate tubular body 24 to an electrical terminal 16b. The terminal 16b is complementary to the terminal 16a on the distal end wall of the housing 13 and is arranged for detachably engaging therewith. The elongate conductor 26 extends either along the surface of the applicator body 24 or spatially separated from the applicator body 24, such that the applicator body 24 defines an insulative layer disposed intermediate the electrical conductor 26 and the second duct 14b. The elongate conductor 26 may also comprise an integral insulative layer such as a plastic coating (not shown). It is preferable to provide at least one insulative layer between the elongate conductor 26 and the second duct 14b in order to minimise the deleterious effect of an electrical current proximal to the second duct 14b on the afterglow of the plasma communicated by the second duct 14b.

Referring to FIG. 2 of the drawings, the monitoring circuit 17 comprises a resistor 171, through which current flows from the annular electrode 25 to a terminal of the battery 22. An amplifier 172 is arranged to amplify the potential difference developed across the resistor 171. It will be appreciated that this potential difference may comprise a series of spikes with respect to time, and thus conditioning means (not shown) may be required in order to convert the potential difference across the resistor 171 into a form compatible with the amplifier 172. The output of the amplifier 172 is applied to one input of a comparator 173. The comparator 173 compares the output of the amplifier 172 with a reference voltage set by a potentiometer 174 on its other input, the reference voltage being indicative of the output of the amplifier that would be measured if the plasma generating portion 20 were working at optimum output. The output of comparator 173 is connected to the power supply circuit 21, so as to control the magnitude of the high voltage applied to the electrodes 18, 19 of the plasma generating portion 20 in dependence on the sensed current flowing from the annular electrode 25 of the applicator portion 12.

In use, the battery 22 powers the electrodes 18, 19 via the power supply circuit 21, creating a large potential difference between the inner electrode 18 and the outer electrode 19. Gas from the gas cylinder 15 passes into the first duct 14a and between the electrodes 18, 19, which ionises the gas particles to produce a discharge plasma. The gas forms an afterglow downstream of the high-voltage electrodes 18, 19, which continues along the first duct 14a into the second duct 14b. The plasma emerges as a plume from the mouth of the second duct 14b and may be directed onto a person's teeth or gums, in order to provide effective tooth whitening.

The end annular electrode 25 of the applicator portion 12 serves to attract electrons being carried in the afterglow. In this manner, any tingling sensation associated with transmission of the electrons to teeth, skin, gums etc is alleviated. Furthermore, the electrons that are attracted by the annular electrode 25 are transmitted along the elongate conductor 26 and to the monitoring circuit 17 via the electrical connection between the two terminals 16a. 16b. The monitoring circuit 17 detects the magnitude of the current associated with the flow of electrons from the annular electrode 25, which provides an indication of the strength of the plasma plume. The magnitude of the potential difference applied across the pair of electrodes 18, 19 is then adjusted in accordance with the sensed current flowing from the annular electrode 25 so as to maintain the plasma generating portion 20 at its optimum working output.

The above-described embodiment relates to a plasma treatment device in which the body portion and applicator portion are detachably engaged. This arrangement offers the advantage that the applicator portion may be disposed of after use for hygiene purposes. However, it will be appreciated that the body portion and applicator portion may alternatively be formed integrally, in which case a single duct with an inlet disposed in the body portion and an outlet disposed in the elongate applicator portion would serve to transmit plasma from the plasma generator to the outlet.

1. A plasma treatment device comprising a plasma generator for generating a plasma in the form of a non-thermal gaseous species in a gas flow, and an elongate duct extending from the generator for conveying the generated plasma to an outlet disposed at a distal end of the duct and for directing a plasma plume formed at the outlet onto a treatment area, wherein the duct comprises an electrode disposed at the outlet for reducing the number of electrons in the plasma existing therefrom, the electrode being connected to a current sink via an electrical conductor to conduct the electrons away.

2. The plasma treatment device as claimed in claim 1, wherein the electrode is annular and surrounds the outlet of the duct.

3. The plasma treatment device as claimed in claim 1, wherein the duct comprises an elongate tubular body formed of a plastic, glass, ceramic or other insulating material and defining a flow passage for the plasma, the electrode being disposed at the distal end of the tubular body.

4. The plasma treatment device as claimed in claim 3, further comprising an insulative body is disposed intermediate the electrical conductor and the tubular body.

5. The plasma treatment device as claimed in claim 4, wherein the electrode comprises a conductive member engaged to the insulative body.

6. The plasma treatment device as claimed in claim 4, wherein the insulative body is formed of a molded material, the conductive member being molded in-situ.

7. The plasma treatment device as claimed in claim 4, wherein the electrode comprises a conductive region deposited on the insulative body.

8. The plasma treatment device as claimed in claim 6, wherein the electrode comprises a molded region of conductive plastic material disposed on the insulative body.

9. The plasma treatment device as claimed in claim 1, wherein the electrode forms a valve arranged to close the outlet upon cessation of the gas flow.

10. The plasma treatment device as claimed in claim 1, further comprising a monitoring circuit for monitoring the current flowing along the electrical conductor and for controlling a parameter of an operating voltage or current applied to the generator.

11. The plasma treatment device as claimed in claim 1, wherein the current sink comprises an electrical ground.

12. The plasma treatment device as claimed in claim 1, wherein the electrode is connected to a terminal of a power supply of the device.

13. The plasma treatment device as claimed in claim 1, further comprising a body portion which houses the plasma generator and an applicator portion which comprises the duct.

14. The plasma treatment device as claimed in claim 13, wherein the body portion forms a handle for holding the device.

15. The plasma treatment device as claimed in claim 13, wherein the applicator portion is detachable from the body portion and wherein the body portion and applicator portion comprise complimentary engaging terminals for connecting the electrical, conductor to the body portion.

16. The plasma treatment device as claimed in claim 13, wherein the power supply is disposed in the body portion of the device.

17. The plasma treatment device as claimed in claim 16, wherein the power supply comprises a battery.

18. The plasma treatment device as claimed in claim 1, wherein the plasma treatment device is a tooth treatment device.
